(19) United States
(12) Patent Application Publication
(10) Pub. No.: US 2002/0117917 A1
(43) Pub. Date: Aug. 29, 2002

(54) Electric-motor drive and automatic door operating device

(75) Inventors: Gerhard Tascher, Bonndorf (DE); Klaus Pfendler, Bonndorf (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/078,004

(22) Filed: Feb. 20, 2002

(30) Foreign Application Priority Data
Feb. 26, 2001 (DE) 101 09 278.4

(51) Int. Cl. H02K 7/10

(52) U.S. Cl. 310/75 R

(57) ABSTRACT

The invention relates to an electric-motor drive with a gear unit, the transmission ratio of which is in the range between 80:1 and 220:1, and to an automatic door operating device, in particular for swinging doors, with such a drive. A particularly quiet and compact drive, which, when used in an automatic door operating device, is suitable both for right-hand-hung and left-hand-hung doors, is characterised in that the gear unit has two stages, the first stage being designed as a worm gear stage and the second stage being designed as a spur gear stage.

### BACKGROUND OF THE INVENTION

The invention is based on a priority application DE 101 09 278.4 which is hereby incorporated by reference.

The invention relates to an electric-motor drive with a gear unit and to an automatic door operating device comprising said electric-motor.

Electric-motor drives with a very high speed reduction between the motor shaft and the output shaft are generally realised by means of multi-stage gear units. Those which are known and customary are above all planet/bevel gear combinations, bevel/spur gear combinations or multi-stage spur gears. These reduction gears are equipped with at least three stages. However, multi-stage drives are relatively expensive and voluminous. Moreover, disturbing noises owing to the various toothing parts are scarcely avoidable.

### SUMMARY OF THE INVENTION

The object on which the invention is based is to specify an electric-motor drive of the generic type which is distinguished by a smaller design and quieter running.

According to the invention, the object is achieved by a electric-motor drive with a gear unit, the transmission ratio of which is at least 80:1, the gear unit shows two stages, the first stage being designed as a worm gear stage and the second stage being designed as a spur gear stage, resulting in a reduction of the size, the costs and the noise generation. Since meshing toothings are now only provided between motor shaft and worm wheel, and between worm wheel shaft and spur wheel, the noise levels and noise frequencies can be more easily influenced in terms of quiet running at a pleasant frequency than, for example, in the case of three-stage bevel/spur gears, in which three toothings cause a disturbance. Bevel gear stages are, moreover, only suitable for a maximum reduction of 6:1. To achieve a total transmission ratio of, for example, 120:1, a further reduction by 20:1 would consequently be necessary, so that conventional drives for such a high total transmission ratio require at least three stages. A reduction to two stages is only possible since the worm gear stage can achieve a transmission ratio of up to 25:1. At an even higher transmission ratio, the efficiency becomes so low that the gear unit becomes self-locking and thus no longer restorable.

In an advantageous further invention, the worm gear stage is preferably equipped with a plastic worm wheel. It has been found that the efficiency of a plastic worm wheel is much better than that of a conventional metal worm wheel. This ultimately makes it possible to produce worm gear stages with a very high transmission ratio, without thereby unacceptably reducing the efficiency. The self-locking tendency is also curbed in the case of the claimed worm/spur gear, that is to say this gear can be returned in the opposite direction with little effort.

These properties are advantageous particularly in the case of an automatic door operating device according to the invention. Here, the drive serves for opening the door, while the spring return element swings the door into a starting position. The spring force can be easily adjusted if required. In addition, with appropriate spring force, the door can be swung into a neutral position for safety reasons, particularly in the case of fire doors or in the event of a power failure.

The specific problem with door drives is that a different design of a conventional automatic door operating device is required for left-hand-hung and right-hand-hung doors.

To solve this problem, the two-stage worm/spur wheel drive permits a symmetrical construction centrally with respect to the gear casing, with the result that the drive is suitable both for right-hand-hung and left-hand-hung doors.

In a further advantageous development, the spring return element preferably acts on the worm wheel shaft of the worm gear stage. In the case of known door drives, the spring which swings the door into the neutral position or the starting position is attached to the output shaft. This necessitates considerable spring torques, coupled with a large and costly construction. Attaching the spring to the worm wheel shaft makes it possible to provide a smaller spring torque, so that ultimately the size and costs are reduced.

Overall, the claimed automatic door operating device with worm/spur gear affords the following advantages over conventional designs:

noise reduction,

reduction of toothing parts,

smaller size and

simple alteration of the transmission by exchanging the worm gear stage.

### BRIEF DESCRIPTION OF THE DRAWINGS

The invention is explained in more detail below with the aid of an exemplary embodiment illustrated in the figures, in which:

FIG. 1 shows a first cross-section through an electric-motor drive and

FIG. 2 shows a second cross-section through the drive according to FIG. 1.

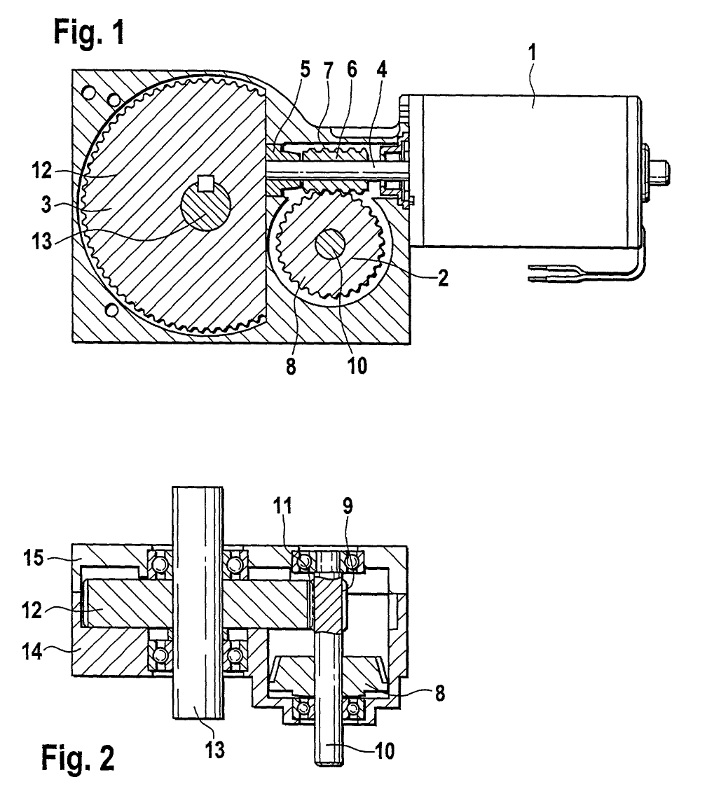

The drive illustrated consists essentially of a drive motor 1, a worm gear stage 2 and a spur gear stage 3. The motor shaft 4, which cooperates with a slide bearing 5, carries a worm 6 with helical toothing 7. The toothing 7 acts on a worm wheel 8, which rotates relative to the motor shaft 4 with a step-down ratio of, for example, 10:1, 15:1 or 24.5:1. A step-down ratio of such magnitude is possible if the worm wheel 8 is of plastic construction. In order to reduce the speed by a further factor of about 10, a pinion 9 (FIG. 2) on the worm wheel shaft 10 corresponds with a helical toothing 1 1 (FIG. 2) of a spur wheel 12. The spur wheel shaft acts as the output shaft 13 of the electric-motor drive.

FIG. 2 shows a section through the gear part of the drive, in which a casing 14 with cover 15 can be seen, the compact construction of the reduction gear for speed reduction of between eighty and two hundred and twenty times being clearly evident.

1. Electric-motor drive with a gear unit, the transmission ratio of which is at least 80:1, wherein in that the gear unit has two stages, the first stage being designed as a worm gear stage and the second stage being designed as a spur gear stage.

2. Drive according to claim 1, wherein the worm gear stage has a plastic worm wheel.

3. Automatic door operating device, in particular for swinging doors, with a drive according to one of the preceding claims and a spring return element, wherein the drive has a symmetrical structural shape suitable for right-hand-hung and left-hand-hung doors.

4. Automatic door operating device according to claim 3, wherein the spring return element acts on the worm wheel shaft of the worm gear stage.
